(19) United States
(12) Patent Application Publication
(10) Pub. No.: US 2009/0158646 A1
(43) Pub. Date: Jun. 25, 2009

(54) ROLLABLE MULCH MAT MADE OF RECYCLED MATERIAL AND RELATED MANUFACTURING METHODS

(75) Inventors: Richard C. Moore, JR., Charleston, SC (US); Sheila B. Jones, McGregor, TX (US)

Correspondence Address: TURNER PADGET GRAHAM & LANEY, P.A., P.O. BOX 1509, GREENVILLE, SC, 29602, US

(73) Assignee: Easy Gardener Products, Inc., Waco, TX (US)

(21) Appl. No.: 11/960,864

(22) Filed: Dec. 20, 2007

(51) Int. Cl. A01G 13/00; B32B 37/14; B32B 38/18

(52) U.S. Cl. 47/9; 156/60; 156/184

(57) ABSTRACT

A mulch mat made of recyclable material is provided having a surface made of recycled material such as rubber and another surface made of a weed inhibiting fabric. The fabric extends from at least one edge of the mat to provide an overlapping area upon which another of the mats sits to prevent weed, grass and other plants from growing between the mats.

### BACKGROUND OF THE DISCLOSURE

Landscape sheet layers are often utilized for a variety of landscaping applications. Landscape sheet layers are often used to deter weed growth, provide erosion control and like. Often landscape sheet layers are applied on the ground, for example, upon the soil of a landscape bed or other landscape region. Landscape sheets are often provided in rolls that are unrolled and cut/overlaid to fit the desired placement location. Landscape sheets not only come in rolls but may alternatively be delivered in a folded format. Landscape sheets may be formed from a variety of materials. Such materials may include solid plastic sheets. Solid plastic sheets are often undesirable because although they may block weed growth and promote erosion control the solid plastic sheets do not allow air and water to penetrate the sheet and flow through to the underlying soil. Thus, solid plastic sheets may result in poor growing conditions and mold as the soil is not allowed to “breath” and water is not allowed to reach plant roots.

To address these problems Landscape sheet layers have also been formed from materials that allow air and water passage but still serve to deter weed growth, provide erosions control and/or provide other beneficial landscaping properties. Materials that allow air and water passage are often referred to as landscape fabrics. Landscape fabrics may be formed, for example, from spunbound or woven materials. Exemplary materials include synthetic materials such as polyethylene, polypropylene or polyester or alternatively natural materials. A combination of natural and synthetic materials may also be utilized.

Irrespective of what type of landscape sheet material is utilized, the landscape sheet materials typically do not have a natural or appealing visually effect for a landscape application. As such, additional materials are often placed on top of the landscape sheet material as part of a complete landscape application. For example, loose organic mulching materials such as bark mulch or nuggets, pine needles, coconut hulls (also called coir) or other organic materials may be placed on top of a landscape sheet after the sheet material has been spread on a landscape area. Unfortunately, these mulching materials are generally bulky, hard to transport and hard to spread.

### BRIEF SUMMARY OF THE DISCLOSURE

The present disclosure is directed in general to a flexible, rollable multi-purpose lawn and garden mat made of a landscape fabric and recycled material such as rubber. The mat is used to create natural but manicured edges along walkways and around trees, shrubbery, flowerbeds, posts, poles, and the like to define lawn boundaries and to inhibit grass and weed growth in these areas and in between the mats. Moreover, the mats- may be used to create larger manicured areas or edges for situating water hose storage carts, outdoor garden supply sheds, playground equipment and the like in order to render mowing or trimming around and under such items unnecessary.

The rollable mulch mat is made, for example, by recycling a waste product such as used rubber tires. The mulch mat may have a variety of colors, for instance, brown, red, black or combinations of these and other colors. The mulch pad may be rolled or folded in such a way that a home improvement store, a garden store or the like need only use a limited amount of floor or shelf space compared to bulkier conventional lawn and garden products.

Evident from the foregoing introduction, the component parts and ingredients of the rollable mulch mat are simple and economical to manufacture and use. Other advantages of the disclosure will be apparent from the following description and the attached drawings or can be learned through practice of the various embodiments described below.

According to one aspect of the present disclosure, a flexible mulch mat includes a first surface including a plurality of rubber components configured to appear as mulch; a second surface in contact with the first surface, the second surface being configured for contact with ground to prevent plant growth; and a section depending from the second surface extending beyond the first surface, the section being configured to underlie an abutment to prevent weed growth therethrough. The rubber components of the first surface may be rubber buffings and rubber granules, which may be derived from rubber tires.

The second surface in this embodiment may be polypropylene material, a polyethylene material, a polyester material or combinations of these and other natural and synthetic materials. An adhesive may be used to adhere the first surface to the second surface.

In this aspect, the first surface and second surface are between about 0.100 inches to about 0.250 inches in cross-section. The first surface may be about 12 inches to about 48 inches in width and about 4 feet to about 10 feet in length. The second surface may project beyond the first surface from about 1 inch to about 2 inches to extend under the abutment formed between the flexible mulch mat and an adjoining mulch mat.

According to another embodiment, a method of manufacturing a flexible mulch mat includes providing a forming surface; mixing together a rubber component and a binder to form a matrix; and attaching a base to the matrix to form a flexible mat on the forming surface. The forming surface may be about 0.100 inches to about 0.250 inches in height to be rollable into a tubular form.

The base may be attached to the matrix by a chemical reaction, heat, an adhesive and combinations thereof.

The method may further include forming a border depending from the base beyond the matrix and placing the flexible mulch mat next to another flexible mulch mat such that an edge of one of the flexible mulch mats covers or overlaps the border depending from the other flexible mulch mat.

The mat may be rolled into a tubular form having a diameter of about five inches to about ten inches.

In a further embodiment, a flexible mulch mat may include a first surface including a plurality of rubber components configured to appear as mulch; a second surface in contact with the first surface, the second surface being configured for contact with ground to prevent weed growth; and a section depending from the second surface extending beyond the first surface, the section being configured to underlie an abutment formed by an adjoining mulch mat and being further configured to prevent weed growth between the abutment, wherein the first and second surface are between about 0.100 inches to about 0.250 inches in cross-section.

### BRIEF DESCRIPTION OF THE DRAWINGS

The above and other aspects and advantages of the present disclosure are apparent from the detailed description below in combination with the drawings, in which:

FIG. 1 is a perspective view of flexible mulch mats shown in an intended use according to an aspect of the disclosure;

FIG. 2 is a perspective view of one of the flexible mulch mats as in FIG. 1 shown in a rolled condition;

FIG. 3 is a perspective view of one of the flexible mulch mats as in FIG. 2 being unrolled;

FIG. 4 is a perspective view of the flexible mulch mats as in FIG. 1 being unrolled together, particularly showing an overlapping operation of a border portion of one of the flexible mulch mats;

FIG. 5 is an elevational view of a cross-section of the flexible mulch mat taken along line V-V in FIG. 3;

FIG. 6 is a perspective view of one the flexible mulch mats as in FIG. 1 being prepared for installation according to another aspect of the disclosure; and

FIG. 7 is a schematic view of a manufacturing line showing a process of forming flexible mulch mats as in FIGS. 1-6 according to a further aspect of the disclosure.

### DETAILED DESCRIPTION OF THE DISCLOSURE

Detailed reference will now be made to the drawings in which examples embodying the present disclosure are shown. The detailed description uses numerical and letter designations to refer to features of the drawings. Like or similar designations of the drawings and description have been used to refer to like or similar parts of various embodiments according the disclosure.

The drawings and detailed description provide a full and detailed written description of the disclosure and of the manner and process of making and using various embodiments, so as to enable one skilled in the pertinent art to make and use them, as well as the best mode of carrying out the disclosure. However, the examples set forth in the drawings and detailed description are provided by way of example only and are not meant as limitations of the disclosure. The present disclosure thus includes any modifications and variations of the following examples as come within the scope of the appended claims and their equivalents.

Turning now to the figures, a flexible mulch pad or mat is shown, which is designated in general by the element number 10 and which generally includes an upper or mulch surface 12, a fabric or base 14 and an overlapping section 16, also referred to herein as an edge or a border. According to exemplary manufacturing processes described in detail below, the flexible mulch mat 10 may be manufactured by chipping, cutting or chopping used tires or other recyclable rubber, or synthetic materials, into pieces 18 made to appear as wood chips, wood shreds, wood nuggets, pebbles, stones, pine needles, or other natural materials. The pieces 18, and thus the surface 12, are attached to the base 14 by the processes discussed below.

In use, the flexible mulch pad 10 appears as a natural mulch covered area. The flexible mulch pad 10 is sufficiently durable to withstand various weather conditions and lasts many times longer than natural mulch, which tends to fade, decompose and become scattered due to wind and foot traffic. Due to its border 16 and other user-friendly installation characteristics, the flexible mulch pad 10 can be used easily with other flexible mulch pads to create relatively large, weed-resistant, covered areas.

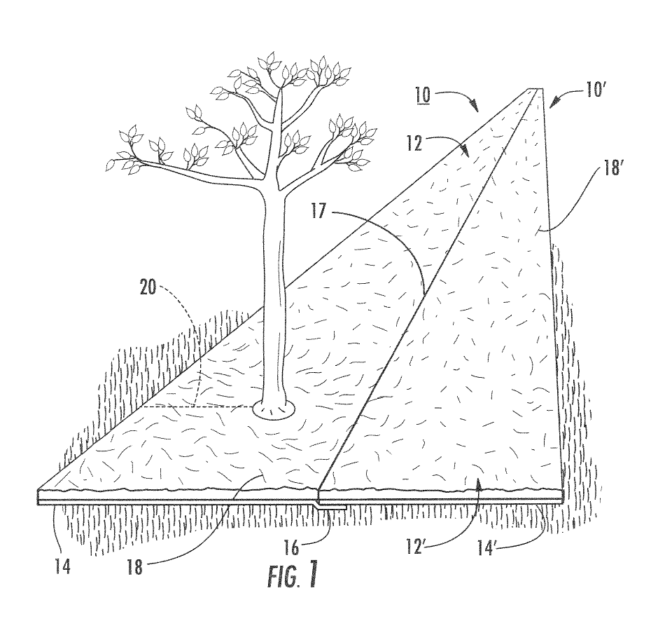

With particular reference to FIG. 1, the exemplary flexible mulch mat 10 is rectangular in shape and optionally has been slit as indicated by element number 20 to fit around a tree in this example. A gardener or groundskeeper also has opted to use another flexible mulch mat, designated by the element number 10′, to create a relatively large covered area. As shown, each of the flexible mulch mats 10, 10′ include respective surfaces 12, 12′ having pieces 18, 18′ as briefly introduced above. As further shown, the flexible mulch mat 10′ overlies the border 16 of the flexible mulch mat 10 to create a weed-blocking barrier between the flexible mulch mats 10, 10′. Without the border 16 between the flexible mulch mats 10, 10′, weeds, grass and other undesired plant life may readily grow between a seam or abutment 17 created between the flexible mulch mats 10, 10′.

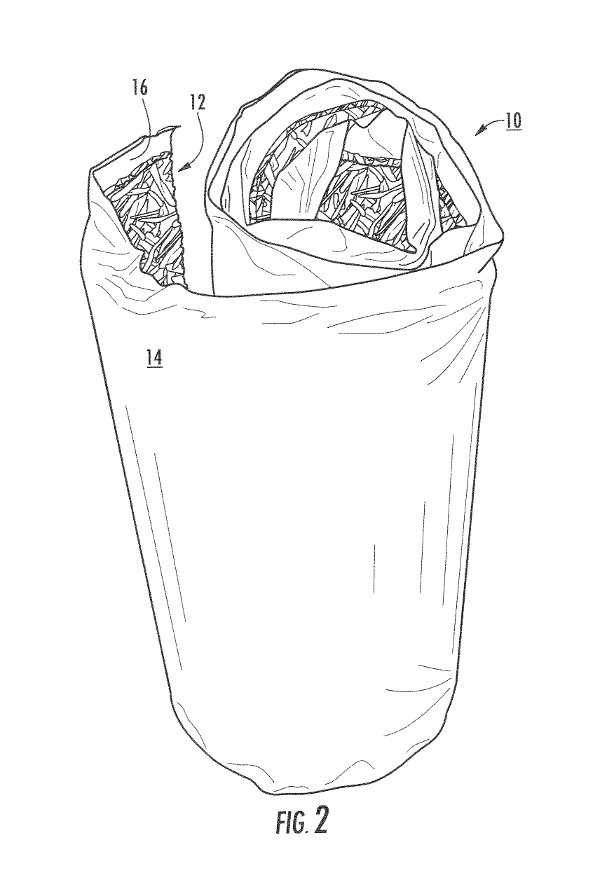

Although many sizes and shapes of the flexible mulch mat 10 are possible, FIG. 2 shows the flexible mulch mat 10 at about eighteen to about forty-eight inches wide by about four to about ten feet long. As shown, the surface 12 and base 14 of the mulch mat 10 have a combined, relatively thin cross section of about 0.100 inches to about 0.250 inches, which provides the mulch mat 10 with sufficient flexibility to be rolled into a tubular shape. Being able to roll mulch mats of 6-10 feet in length (or longer) into tubular forms having diameters of only about seven inches reduces retail floor space required to store and display the mats 10 and also provides a consumer with relatively compact packages for carrying and transporting the mats 10 from the retail store to the project site. Additionally, less material is required to manufacture the mats 10, which results in reduced manufacturing costs and ultimately, savings to the consumer.

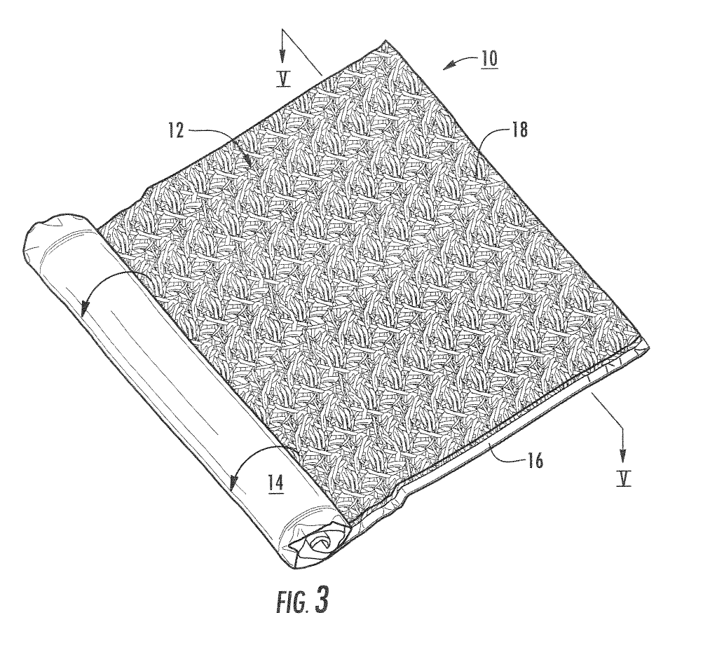

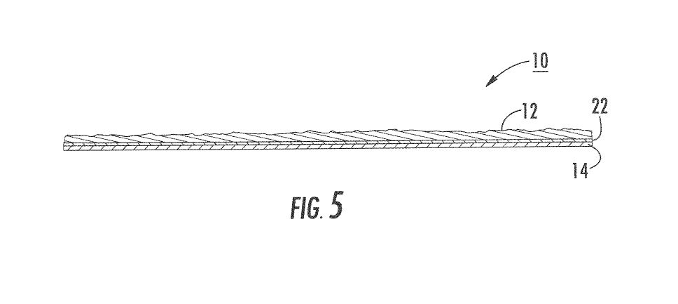

As shown in FIGS. 3-5, the base 14 and the border 16 of the flexible mulch mat 10 are made from a fabric such as a non-woven polypropylene material, or a UV-treated polyethylene such as ProWeedBlock® Landscape Fabric available from EASY GARDENER of Waco, Tex. The fabric base 14 increases structural integrity to allow the surface 12 to be a thinner layer. Other exemplary materials that may be utilized for the base 14 include synthetic materials such as polyester, or alternatively, natural materials or a combination of natural and synthetic materials. Natural materials may include compressed or non-compressed organic material. The base 14 and the border 16 block sunlight and therefore prevent growth of weeds, grass and other plant life. As introduced above, the base 14 may be attached to the pieces 18 by melt processes, adhesives or the like. For instance, the pieces 18 making up the surface 12 may be adhered to the base 14 by an adhesive 22 as shown in FIG. 5.

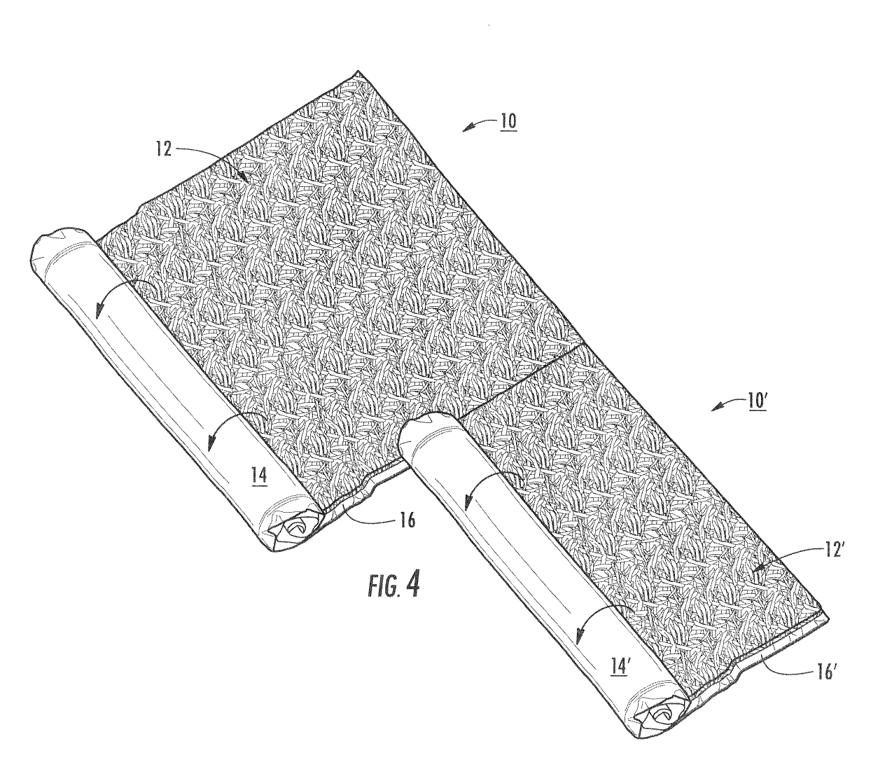

FIG. 4 most clearly shows the border 16 extending from the base 14 by about one to two inches, although the border 16 may be narrower or wider as required. Stated another way, a length, a width or an area of the surface 12 may be smaller than the base 14 to form the border 16. Although not shown, the border 16 may extend from two or more edges of the flexible mulch mat 10. Accordingly, at least one edge of the second mulch mat 10′ may be placed over the border 16 to form a barrier between the abutted mulch mats 10, 10′ to prevent growth of weeds and grass between the mats 10, 10′.

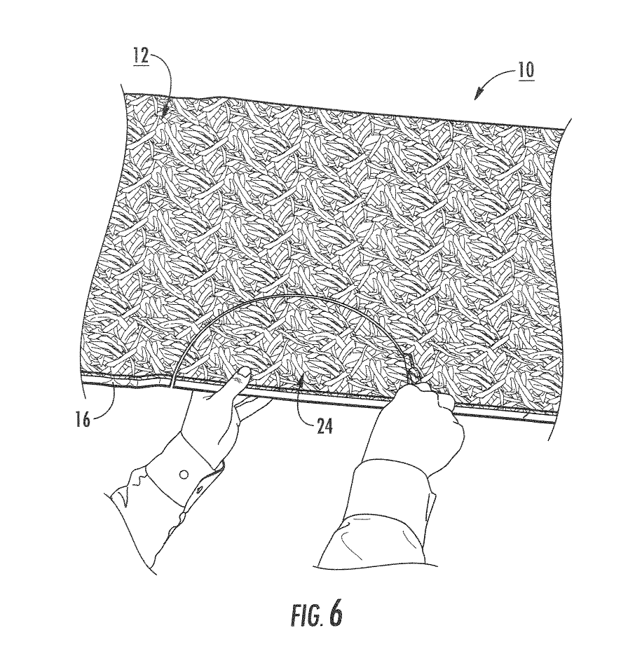

As shown in FIG. 6, the flexible mulch mat 10 is pliable and sufficiently thin in cross-section for a gardener to cut through the surface 12, the base 14 and the border 16 to remove a portion 24 of the flexible mulch mat 10 to fit around part of a tree trunk, a post or the like (see e.g., FIG. 1). Unused portions of the border 16 are also easily trimmed away; e.g., from edges that are not abutting or underlying another mulch mat 10′. Additionally or alternatively, the unused portions of the border 16 may folded under the mulch mats 10, 10′. Still further, a perimeter of approximately one to two inches of the surface 12 may be unattached to the base 14 to permit the consumer to tuck the unused portion of the border 16 of the mulch mat 10 between the surface 12′ and the base 14′ of the connecting mat 10′. The mats 10, 10′ may then be stapled to the ground without staples or the unused portions of the border 16 showing.

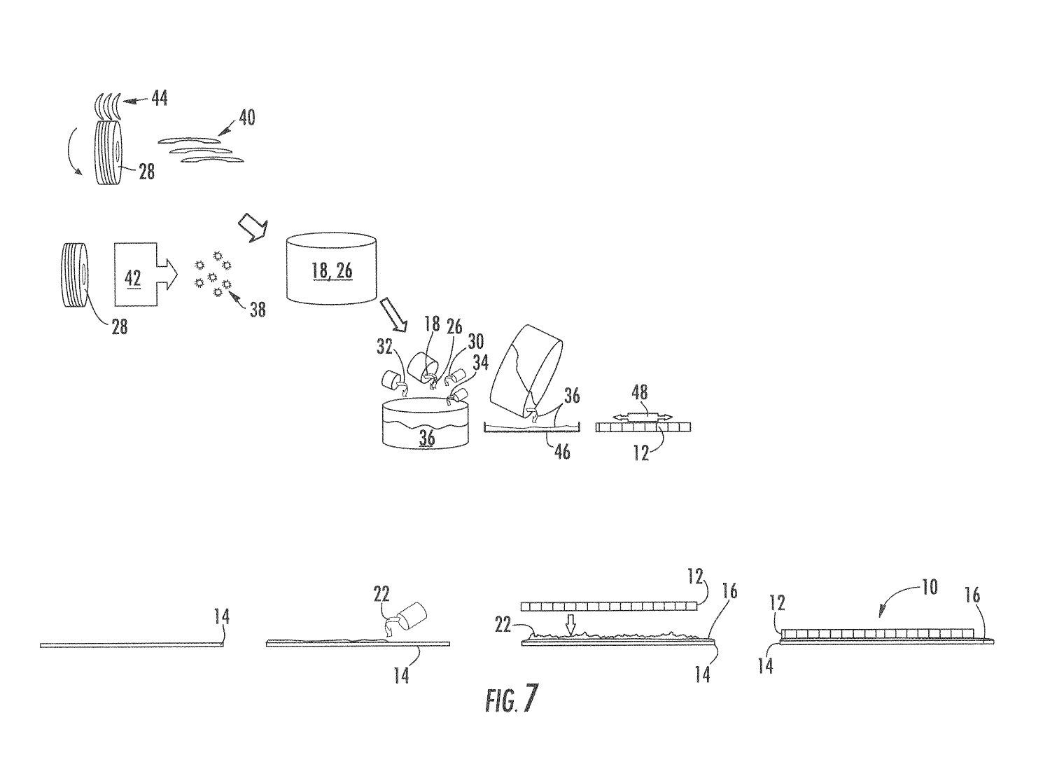

The disclosure may be better understood with reference now to a process shown in FIG. 7. As briefly introduced above and shown here, the mulch mat 10 may be made of rubber 18, and possibly fibers 26, from used tires or retread pieces 28 or other rubber sources. The rubber 18, the fibers 26, a curable binder 30, one or more coloring agents or pigments 32 and/or a catalyst 34 are mixed together to form a matrix or mixture 36 used to generate the mulch mat 10. By way of example, the final mixture 36 by weight may be about 75% to 77% rubber granules 38; 12 to 14% rubber buffings 40; about 0 to 2% fiber 26; about 11% binder 30; about 2 to 5% coloring agent 32 by weight of total binder; about 0.01 to 0.03% catalyst 34 by weight of total binder; and a negligible percentage of UV light stabilizers and anti-oxidants. Such a mixture 36, when cured, weighs about 1.25 grams per cubic centimeter, and has a solids-to-voids volumetric ratio of about 5 to 1. Of course, this ratio can be adjusted by varying the sizes of the rubber granules 38 and/or the rubber buffings 40. For example, an increase in particle size 38, 40 will generally provide more air volume while a decrease in particle size 38, 40 will generally provide less air volume.

The curable binder 30 introduced in FIG. 7 may be a latex or a urethane binder such as moisture curable, polyurethane, #2040, manufactured by the ICI Polyurethane division of ICI Americas Inc. The coloring agents 32 may be an iron oxide pigment, No. 4701, manufactured by PDI of ICI Americas, Inc., or any other suitable pigment. To control sheen or gloss for a more natural-like appearance, the coloring agents 32 may also include an anti-gloss agent, or a separate agent such as diatomaceous silica, such as celite #499 manufactured by Manville Filtration and Minerals. The diatomaceous silica is, for instance, sprinkled on the surface of the uncured, molded mixture 36 to provide an anti-gloss effect. An exemplary catalyst for use as the catalyst 34 is Dabco No. T-12 manufactured by Air Products and Chemicals Company. The skilled artisan will appreciate that these sources and brands are provided by example only and any suitable pigment, anti-gloss additives, binders and the like may be used.

With continued reference to FIG. 7, the rubber 18 can be obtained from the used tires 28 in the form of the granules 38 or the finger-like buffings 40 as noted above. For instance, when the used tires 28 are ground in a granulator 42, steel components are removed, leaving the rubber granules 38. As shown, the granules 38 are generally in the range of about ⅛ inch to about ¾ inch in major dimension. If buffings 40 are desired in the final product, a buffing machine 44 is rotated about the tire 28 (or vice versa) to shed the buffings 40 (e.g., about 0.5 inches to about 3 inches in length and about 0.25 to about 1 inch in width). Either or both the granules 38 and the buffings 40 can be used in the mixture 36, keeping in mind the granules 38 provide a more pebble-like appearance while the buffings 40 will appear more like wood mulch.

As further shown in the example of FIG. 7, the mixture 36 is poured onto a forming surface 46, such as a conveyor belt or a mold, to a thickness ranging from about one 0.100 inches to about 0.250 inches, although other thickness can be produced as noted above. More specifically, the forming surface 46 is about ¾ of the desired thickness of the mulch mat 10. The forming surface 46 also has a width that dictates the width of the surface 12.

FIG. 7 further shows that the mixture 36 may be smoothed with a smoothing device 48—or manually leveled—substantially even with a top of the forming surface 46 to form the surface 12. Simultaneously, or subsequently, the base 14 is prepared by applying a layer of adhesive 22. As shown, the surface 12 is conveyed to the adhesive-coated base 14 and the components are pressed together to form the mulch mat 10. Once the components of the mulch mat 10 are cured together, the mulch mat 10 is rolled up, packaged (such as in shrink wrap) and shipped to retailers.

Alternative means of bonding the surface 12 and the base 14 include heat-pressing the components together using, for instance, a urethane bond. The skilled artisan will further recognize that the base 14 can be transported and applied to the surface 12 rather than as shown in FIG. 7. Moreover, the base 14 could be placed on the forming surface 46 and the heated mixture 36 deposited onto the base 14 to form the mulch mat 10. Thus, the disclosure is not limited to the exemplary manufacturing process shown in FIG. 7.

While preferred embodiments of the disclosure have been shown and described, those skilled in the art will recognize that other changes and modifications may be made to the foregoing examples without departing from the scope and spirit of the disclosure. For instance, dimensions such as areas, lengths, and widths of the mats can be changed to accommodate various lawn and garden requirements. Likewise, the border may be about 1 inch on one side of the mat but less or more on other sides of the mat. Still further, different rubber or other durable elastomeric materials can be used to manufacture the mat described herein. It is intended to claim all such changes and modifications as fall within the scope of the appended claims and their equivalents,

That which is claimed:

1. A flexible mulch mat, comprising:
a first surface including a plurality of rubber components configured to appear as mulch;
a second surface in contact with the first surface, the second surface being configured for contact with ground to prevent weed growth; and
a section depending from the second surface extending beyond the first surface, the section being configured to underlie an abutment to prevent weed growth therethrough.

2. The flexible mulch mat as in claim 1, wherein the rubber components of the first surface are selected from the group consisting of rubber buffings and rubber granules.

3. The flexible mulch mat as in claim 2, wherein the rubber buffings and rubber granules are derived from rubber tires.

4. The flexible mulch mat as in claim 1, wherein the second surface is selected from the group consisting of a polypropylene material, a polyethylene material, a polyester material and combinations thereof.

5. The flexible mulch mat as in claim 1, wherein the first and second surfaces are between about 0.100 inches to about 0.250 inches in cross-section.

6. The flexible mulch mat as in claim 1, wherein the first surface is about 12 inches to about 48 inches in width.

7. The flexible mulch mat as in claim 1, wherein the first surface is about 4 feet to about 10 feet in length.

8. The flexible mulch mat as in claim 1, wherein the second surface projects beyond the first surface from about 1 inch to about 2 inches.

9. The flexible mulch mat as in claim 1, wherein the abutment is formed between the flexible mulch mat and an adjoining mulch mat.

10. The flexible mulch mat as in claim 1, further comprising an adhesive being configured to adhere the first surface to the second surface.

11. A method of manufacturing a flexible mulch mat, comprising:
providing a forming surface;
mixing together a rubber component and a binder to form a matrix;
attaching a base to the matrix to form a flexible mat on the forming surface, the flexible mat being configured to form a roll; and
forming a border depending from the base beyond the matrix.

12. The method as in claim 11, wherein the forming surface defines a height of about 0.100 inches to about 0.250 inches.

13. The method as in claim 11, wherein the base is attached to the matrix by a chemical reaction, heat, an adhesive and combinations thereof.

14. The method as in claim 11, further comprising placing the flexible mulch mat next to another flexible mulch mat such that an edge of one of the flexible mulch mats covers the border depending from the other flexible mulch mat.

15. The method as in claim 11, wherein the edge overlaps the border.

16. The method as in claim 11, further comprising rolling the mat into a tubular form having a diameter of about five inches to about ten inches.

17. A flexible mulch mat, comprising:
a first surface including a plurality of rubber components configured to appear as mulch;
a second surface in contact with the first surface, the second surface being configured for contact with ground to prevent weed growth; and
a section depending from the second surface extending beyond the first surface, the section being configured to underlie an abutment formed by an adjoining mulch mat and being further configured to prevent weed growth between the abutment, wherein the first and second surface are between about 0.100 inches to about 0.250 inches in cross-section.

18. The flexible mulch mat as in claim 17, wherein the rubber components of the first surface are selected from the group consisting of rubber buffings and rubber granules.

19. The flexible mulch mat as in claim 18, wherein the rubber buffings and rubber granules are derived from rubber tires.

20. The flexible mulch mat as in claim 17, wherein the second surface is selected from the group consisting of a polypropylene material, a polyethylene material, a polyester material and combinations thereof.
